(19) United States
(12) Patent Application Publication
(10) Pub. No.: US 2004/0157585 A1
(43) Pub. Date: Aug. 12, 2004

(54) Mobile communication network system and mobile terminal authentication method

(75) Inventor: Toshiyuki Sashihara, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/769,998

(22) Filed: Feb. 3, 2004

(30) Foreign Application Priority Data
Feb. 5, 2003 (JP) 2003-028188

(51) Int. Cl. H04M 1/66

(52) U.S. Cl. 455/411

(57) ABSTRACT

When an AAAh server in a home domain receives an authentication request message from an mobile IP terminal in a visited domain, the AAAh server transmits a secret key generated by a secret key generating unit to an AAAv server in the visited domain and to the mobile IP terminal. Consequently, an authority to authenticate the mobile IP terminal is assigned from the AAAh server in the home domain to the AAAv server in the visited domain. When the AAAv server receives an authentication request from the mobile IP terminal, the AAAv server directly performs the authentication without exchanging messages with the AAAh server.

### BACKGROUND OF THE INVENTION

1. Field of the Invention

The present invention relates to a mobile communication network system in which a visited network formed in a visited domain and a home network formed in a home domain connect with each other over the Internet. In particular, the present invention relates to a mobile terminal authentication method for authenticating a mobile IP terminal existing in the visited domain.

2. Related Art

A launch of a hot spot service, which provides a high-speed Internet access service outdoor, is under way, using a wireless LAN(Local Area Network) technique such as IEEE802.11b. The Internet uses an IP(Internet Protocol) as a network layer protocol. The IP is designed with an assumption that nodes are fixed so that they never move. As such, in order to enable users to move wide area while continuing communications using the aforementioned hot spot service, it is required to use a technique called Mobile IP.

In the conventional Mobile IP technique, it is not well considered to provide a commercial service over a large-scale Mobile IP network. In order to complement this disadvantage, the AAA(Authentication Authorization Accounting) working group of the IETF(The Internet Engineering Task Force) is now working for standardizing an AAA(Authentication Authorization Accounting) protocol called “DIAMETER”. The AAA protocol realizes functions such as authenticating a user who may move using the Mobile IP, collecting accounting information, and assigning a home agent and a home address. These techniques are disclosed in the Japanese Patent Application Laid-open No. 2002-176445, No. 2002-344479, No. 2001-103574, and No. 2001-308932.

FIG. 1 shows the structure of a conventional mobile communication network system using the Mobile IPv6 and the “DIAMETER” protocol. Here, it is assumed that the “DIAMETER” base protocol and the “DIAMETER” Mobile IPv6 application are applied as the “DIAMETER” protocol.

Referring to FIG. 1, the conventional mobile communication network system comprises, a home network formed in a home domain 10, a visited network formed in a visited domain 20, and a mobile IP terminal (indicated as MN(mobile node) in the Figure) which is a movable user terminal (mobile terminal) 130. The home network and the visited network connect with each other over the Internet 40.

The home domain 10 is a domain managed by a provider with which a user of the mobile IP terminal 130 signs up for using the network. In other words, it is a domain where the home network, to which the user of the mobile IP terminal 130 subscribes, is formed. The mobile IP terminal 130 usually performs mobile communications using the home network in the home domain 10. The visited domain 20 is a domain, other than the home domain 10, to which the mobile IP terminal 130 is connecting (or intends to connect).

The home network formed in the home domain 10 comprises a router 11 and an AAAh server 112 which is an AAA server installed in the home domain. The AAAh server 112 holds information such as a secret key required for authenticating the mobile IP terminal 130.

The visited network formed in the visited domain 20 comprises a router 21, an AAAv server 122 which is an AAA server installed in the visited domain 20, a local home agent(LHA) 23, and AAA clients 24, 25.

The LHA 23 is a node installed in the visited domain 20. In a case that the LHA 23 is assigned as the home agent to the mobile IP terminal 130, the LHA 23 serves to transfer a packet, which is transmitted being addressed to the home address of the mobile IP terminal 130, to the mobile IP terminal 130.

The AAA clients 24, 25 perform a client function of the “DIAMETER” protocol, as well as a router function for routing a packet of the mobile IP terminal 130 to the Internet 40 side, and filtering by which only packets from users authorized to access are filtered out.

Next, referring to FIG. 2, an explanation will be given for a sequence in a case that the mobile IP terminal(MN) connects with the AAA client 24 in the visited domain in the conventional mobile communication network system.

First, the mobile IP terminal 130 transmits an authentication request message to the AAA client 24 (step 301). Then, the AAA client transmits to the AAAv server 122, an ARR(AA-Registration-Request) message addressed to the AAAh server 112 (step 302).

The AAAv server 122, upon receipt of the ARR message, transfers the received ARR message using a routing table held by the AAAv server 122. Here, it is assumed that the received ARR message is transferred to the AAAh server 112 in the home domain 110 (step 303).

The AAAh server 112 authenticates the mobile IP terminal 130 referring to the message parameter included in the transferred ARR message, and authorizes to use the source. The authentication of the mobile IP terminal 130 uses a secret key shared by the mobile IP terminal 130 and the AAAh server 112. Further, when authorizing the use of the source, the AAAh server 112 determines the place where the home agent is assigned to, based on a request from the mobile IP terminal and the policies set in the AAAh server 112. In this example, the home agent is assigned in the visited domain 120.

Then, the AAAh server 112 transmits a home agent request(HOR:Home-Agent-MIPv6-Request) message to the visited domain (step 304). The AAAv server 122, upon receipt of the HOR message from the AAAh server 112, assigns the home agent and the home address, and transmits the HOR message to the assigned home agent (in this example, LHA 23) (step 305). The LHA 23, upon receipt of the HOR message, updates a binding cache entry, which is used when transferring a packet, and returns an HOA(Home-Agent-MIPv6-Answer) message, which is a reply message to the HOR message, to the AAAv server 122 (step 306).

The AAAv server 122, upon receipt of the HOA message from the LHA 23, transfers the received HOA message to the AAAh server 112 (step 307). The AAAh server 112, upon receipt of the HOA message from the AAAv server 122, returns an ARA(AA-Registration-Answer) message, which is a reply message to the ARR message, to the AAAv server 122 (step 308).

The AAAv server 122, upon receipt of the ARA message from the AAAh server 112, transfers the received ARA message to the AAA client 24 (step 309). The AAA client 24, upon receipt of the ARA message from the AAAv server 122, transmits an authentication reply message to the mobile IP terminal 130 (step 310).

Next, an explanation will be giving for a case that the mobile IP terminal 130 moves within the visited domain 20 and connects with the AAA client 25 replacing the AAA client 24. Here, the aforementioned sequence of the steps 301 to 310 is completely the same, except that the AAA client 24 is replaced with the AAA client 25 (steps 311 to 320).

It should be noted that the aforementioned sequence is an example, and it does not include a disconnection of a session when moving, or messages in a case of using an advanced authentication such as a two-way authentication performed between the mobile IP terminal 130 and the AAAh server 112.

In the conventional method of authenticating the mobile IP terminal 130 when the mobile IP terminal 130 moves within the same domain as described above, there is a following problem. That is, each time the mobile IP terminal 130 moves within the domain, a message exchange of two round trips (the steps 313, 314, and the steps 317, 318) must be performed between the AAAv server 122 and the AAAh server 112.

In a case that the home domain 10 and the visited domain 20 are extremely distant in the network topology, for example, the home domain 10 is in Japan and the visited domain 20 is in Europe, a time period required for the two round trips may be a second time scale. During the period from the time the mobile IP terminal 130 transmits an authentication request by the time it receives the reply message (steps 311 to 320), the mobile IP terminal 130 is not authenticated and is not authorized to use the source, so that the user of the mobile IP terminal 130 cannot use the network. Therefore, if the mobile IP terminal 130 receives a voice communication service using the VoIP(Voice Over IP) or the like, the user cannot appreciate the voice communication service during the period of the second time scale during which communications are impossible, which leads to a fatal defect as a service.

Here, it is possible to prevent an occurrence of the period during which communications are impossible, by not performing an authentication when the mobile IP terminal 130 moves within the visited domain 20. However, if the authentication is not performed, accessing from a user having no authority to access the network cannot be prevented. Accordingly, a method, which keeps a function of preventing an access from a user having no authority to access the network and also reduces an authentication period, is required.

In the conventional mobile communication network system described above, it is required to authenticate by performing message exchanges of two round trips between the AAAv server and the AAAh server each time the mobile IP terminal moves within the visited domain. Therefore, there is a problem that a period, during which communications are impossible, becomes long.

It is therefore an object of the present invention to provide a mobile communication network system and a mobile terminal authentication method which is capable of, when a mobile IP terminal moves within a visited domain so that an authentication is required, keeping a function of preventing an access from a user having no authority to assess the network, eliminating message exchanges of two round trips between the AAAv server and the AAAh server, and considerably reducing a time period necessary for the authentication.

In order to achieve the aforementioned object, a mobile terminal authentication method according to the present invention is a mobile terminal authentication method in a mobile communication network system in which a home network, to which a mobile terminal subscribes, and a visited network, to which the mobile terminal does not subscribe, connect with each other over the Internet. The mobile terminal authentication method is such a method that an authentication of a mobile terminal moved from a domain of the home network to a visited domain of the visited network is performed by an AAAv server in the visited network. The method comprises the steps of: notifying, from the AAAv server in the visited network to an AAAh server in the home network, an authentication request from the mobile terminal moved to the visited domain of the visited network; and upon receipt of the notification, issuing, from the AAAh server in the home network to the AAAv server in the visited network, a temporal secret key which is to be shared by the mobile terminal and the AAAv server, and assigning an authority to authenticate the mobile terminal to the AAAv server.

Further, the mobile terminal authentication method of the present invention is a mobile terminal authentication method in a mobile communication network system in which a home network to which a mobile terminal subscribes and a visited network to which the mobile terminal does not subscribe connect with each other over the Internet, for authenticating the mobile terminal existing in the visited domain within which the visited network is formed, and the method comprises the steps of: when the mobile terminal existing in the visited domain makes an authentication request to the AAAv server in the visited network, transmitting the authentication request received by the AAAv server to the AAAh server in the home network of the mobile terminal; by the AAAh server, receiving the authentication request from the AAAv server and authenticating the mobile terminal, as well as generating a secret key to be shared temporarily by the mobile terminal and the AAAv server; by the AAAh server, transmitting the generated secret key to the AAAv server from which the authentication request was transmitted and to the mobile terminal, respectively; when an authentication is required again since the mobile terminal moves, making an authentication request from the mobile terminal to the AAAv server based on information generated using the secret key transmitted from the AAAh server; and authenticating, by the AAAv server, the mobile terminal using the information included in the authentication request transmitted from the mobile terminal and the secret key transmitted from the AAAh server.

In the present invention, when a mobile terminal existing in a visited domain, in which a visited network is formed, makes an authentication request to the AAAv server of the visited network for the first time, the AAAv server transmits the authentication request from the mobile terminal to the AAAh server which is an AAA server in the home domain for which the mobile terminal has signed up, to thereby authenticate the mobile terminal. However, when the mobile terminal makes an authentication request next time or later, the AAAv server authenticates the mobile terminal using the secret key from the AAAh server and information included in the authentication request of the mobile terminal. Therefore, the AAAv server of the visited network is capable of authenticating the mobile terminal without transmitting to the AAAh server of the home network the authentication request from the mobile terminal. This can significantly reduce a time period required for authenticating the mobile terminal.

Further, another mobile terminal authentication method of the present invention is a mobile terminal authentication method in a mobile communication network system in which a home network to which a mobile terminal subscribes and a visited network to which the mobile terminal does not subscribe connect with each other over the Internet, for authenticating the mobile terminal existing in the visited domain within which the visited network is formed, and the method comprises the steps of: when the mobile terminal existing in the visited domain makes an authentication request to the AAAv server in the visited network, transmitting the authentication request received by the AAAv server to the AAAh server in the home network of the mobile terminal; by the AAAh server, receiving the authentication request from the AAAv server and authenticating the mobile terminal, as well as generating a secret key to be shared temporarily by the mobile terminal and the AAAv server; by the AAAh server, transmitting the generated secret key to the AAAv server from which the authentication request was transmitted and to the mobile terminal, respectively; by the AAAv server, assigning a home agent to the mobile terminal, setting a lifetime which is a time period within which the mobile terminal can use the home agent, and storing information about the lifetime and the time the lifetime was set; when an authentication is required again since the mobile terminal moves, making an authentication request by the mobile terminal to the AAAv server based on information generated using the secret key transmitted from the AAAh server; authenticating, by the AAAv server, the mobile terminal using the information included in the authentication request transmitted from the mobile terminal and the secret key transmitted from the AAAh server; if the home agent which has been assigned to the mobile terminal coincides with the home agent which is assigned this time, calculating a remaining period within which the mobile terminal can use the home agent based on a current time, the lifetime of the home agent stored, and the time the life time was set; and if the remaining period is longer than a certain time period set beforehand, transmitting an authentication reply message to the mobile terminal before transmitting a home agent request message to the home agent.

According to the present invention, by reducing the time period required for exchanging the home agent request message and the home agent reply message between the AAAv server and the home agent, it is possible to further reduce the time period by the time the mobile terminal receives the authentication reply message.

Further, in another mobile terminal authentication method of the present invention, the information, generated by the mobile terminal using the secret key transmitted from the AAAh server when the authentication request is made to the AAAv server, may be a response value calculated using a challenge value, which may take any value, and the secret key, or a response value calculated using current time information and the secret key.

Further, in another mobile terminal authentication method of the present invention, a method of transmitting, by the AAAh server, the generated secret key to the AAAv server from which the authentication request was transmitted and to the mobile terminal, may be a method in which the secret key is encrypted using another secret key which is different from the generated secret key and has been set beforehand for the AAAh server and the AAAv server, and using yet another secret key which is different from the generated secret key and has been set beforehand for the AAAh server and the mobile terminal, respectively, before transmitted.

### BRIEF DESCRIPTION OF DRAWINGS

FIG. 1 is a block diagram showing the structure of a conventional mobile communication network system;

FIG. 2 is a sequence chart showing the operation of the mobile communication network system in FIG. 1;

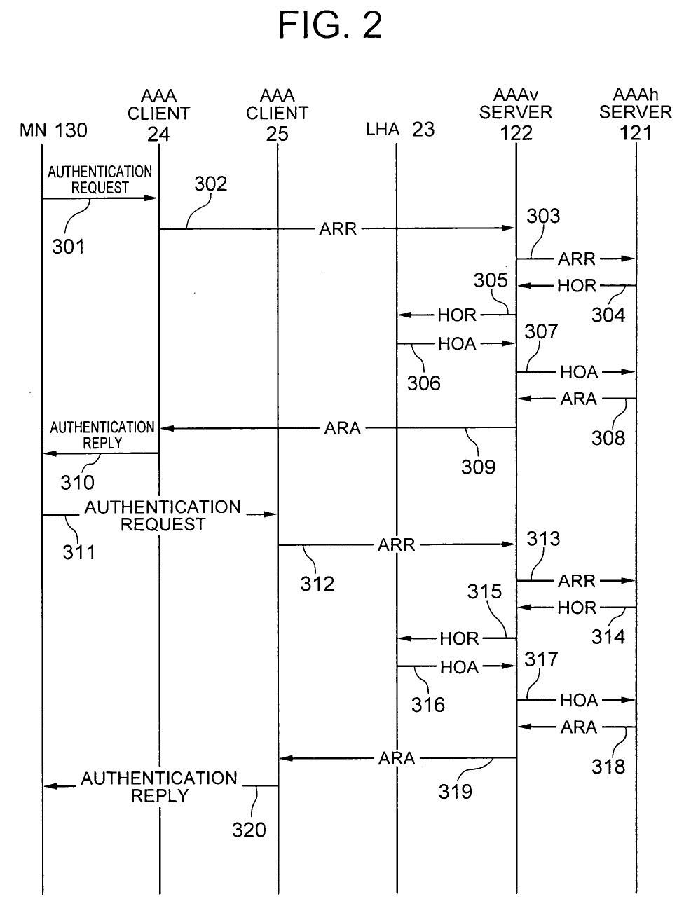

FIG. 3 is a block diagram showing the structure of a mobile communication network system according to a first embodiment of the present invention;

FIG. 4 is a sequence chart showing the operation of the mobile communication network system in FIG. 3;

FIG. 5 is a block diagram showing the structure of a mobile communication network system according to a third embodiment of the present invention;

FIG. 6 is a sequence chart showing the operation of the mobile communication network system in FIG. 5.

### PREFERRED EMBODIMENTS OF THE INVENTION

Next, embodiments of the present invention will be explained in detail with reference to the drawings.

(First Embodiment)

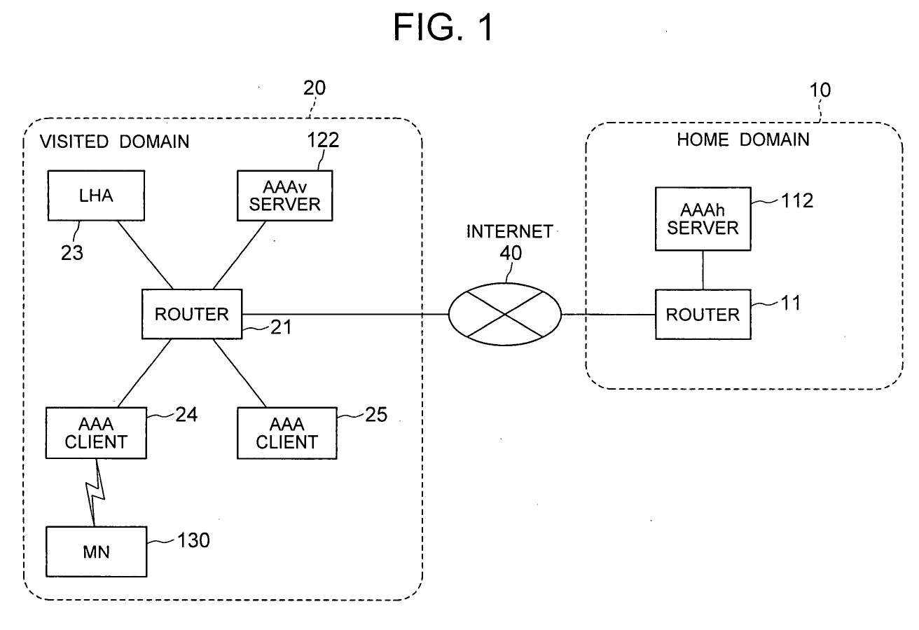

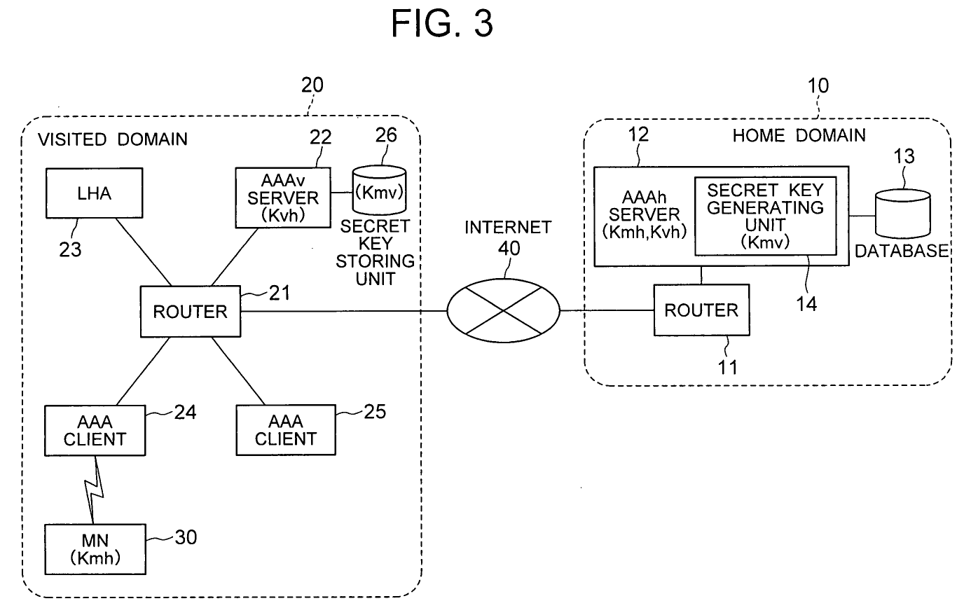

FIG. 3 is a block diagram showing the structure of a mobile communication network system according to a first embodiment of the present invention. In FIG. 3, same reference numerals are used to denote same components as that in FIG. 1 and their explanations are omitted.

The mobile terminal authentication method according to the present invention is a mobile terminal authentication method in a mobile communication network system in which a home network (10), to which a mobile terminal 30 subscribes, and a visited network (20), to which the mobile terminal 30 does not subscribe, connect with each other over the Internet 40. The mobile terminal authentication method is such a method that an authentication of the mobile terminal 30 moved from a domain 10 of the home network to a visited domain 20 of the visited network is performed by an AAAv server 22 in the visited network. The method comprises the steps of: notifying, from the AAAv server 22 in the visited network to an AAAh server 12 in the home network, an authentication request from the mobile terminal 30 moved to the visited domain of the visited network; and upon receipt of the notification, issuing, from the AAAh server 12 in the home network to the AAAv server 22 in the visited network, a temporal secret key which is to be shared by the mobile terminal 30 and the AAAv server 22, and assigning an authority to authenticate the mobile terminal 30 to the AAAv server 22.

A mobile communication network system for performing the mobile terminal authentication method of the present invention is a mobile communication network system in which a home network (10), to which a mobile terminal 30 subscribes, and a visited network (20), to which the mobile terminal 30 does not subscribe, connect with each other over the Internet 40. The visited network (20) includes the AAAv server 22. The AAAv server 22, when receiving an authentication request from the mobile terminal 30 for the first time, transmits the authentication request to the AAAh server 12 in the home network of the mobile terminal to thereby authenticate the mobile terminal 30, and holds a secret key received from the AAAh server 12 with the authentication result, and when receiving an authentication request from the mobile terminal 30 next time, authenticates the mobile terminal 30 using information included in the authentication request transmitted from the mobile terminal 30 and the secret key which has been held by itself.

The home network (10) includes the AAAh server 12. The AAAh server 12 has a secret key generating means (14) for generating a secret key which is to be shared temporarily by the mobile terminal 30 and the AAAv server 22, and when receiving an authentication request from the AAAv server 22, authenticates the mobile terminal 30 and transmits the secret key generated by the secret key generating means to the AAAv server 22 from which the authentication request was transmitted and to the mobile terminal.

Using, as a trigger, the authentication request from the mobile terminal 30 in the visited domain 20 in which the visited network is formed, the authentication of the mobile terminal 30 by the AAAv server 20 in the visited network is performed using the secret key transmitted from the AAAh server 12 in the home network (10).

Now, the present invention will be explained more specifically. A mobile communication network system for performing the mobile terminal authentication method of the present invention comprises, as shown in FIG. 3, a home network formed in the home domain 10, a visited network formed in the visited domain 20, and a mobile IP terminal 30 which is a user terminal. In the present embodiment, the home network and the visited network are connected over the Internet 40 as same as the conventional example shown in FIG. 1.

In the present embodiment, the home network formed in the home domain 10 comprises a router 11, an AAAh server 12, and a database 13.

The AAAh server 12 in the present embodiment is an AAA server installed in the home domain 10, having a secret key generating unit 14 for generating a secret key Kmv which is temporarily shared by the mobile IP terminal 30 and the AAAv server 22. In the database 13, there are registered a secret key for use in authenticating each user and a service list which can be used by the user, and the like. The AAAh server 12 is set to perform necessary processing referring to data registered in the database 13.

In the present embodiment, the visited network formed in the visited domain 20 comprises a router 21, an AAAv server 22, an LHA(Local Home Agent) 23, and AAA clients 24, 25.

The AAAv server 22 in the present embodiment is an AAA server installed in the visited domain 20 and includes a secret key storing unit 26. The secret key storing unit 26 is set to store the secret key Kmv which is issued by the AAAh server 12 to the mobile IP terminal 30 and is temporarily used.

The mobile IP terminal 30 in the present embodiment is different in the following structure, comparing with the mobile IP terminal 130 in the conventional mobile communication network system shown in FIG. 1. That is, after receiving the secret key Kmv from the AAAh server 12, the mobile IP terminal 30 of the present invention makes an authentication request to the AAAv server 22 using the secret key Kmv. This point is different from the conventional one.

In the mobile communication network system of the present embodiment, in order to secure the security of the communicating contents between the mobile IP terminal 30 and the AAAh server 12, and between the AAAv server 22 and the AAAh server 12, a secret key has been shared beforehand between them, respectively.

Here, it is assumed that the mobile IP terminal 30 and the AAAh server 12 share a secret key Kmh, and the AAAv server 22 and the AAAh server 12 share a secret key Kvh. These secret keys Kmh, Kvh are used for encrypting information between respective nodes. These secret keys Kmh, Kvh may be exchanged by speaking, or a key exchange protocol such as IKE or Kerberos V5 may be used.

Further, in the mobile communication network system of the present embodiment, only one mobile IP terminal 30 is given for simplifying the explanation. Practically, there are multiple mobile IP terminals. Therefore, it is assumed that each mobile IP terminal has had an NAI(Network Access Identifier) which is an identifier for identifying each mobile IP terminal.

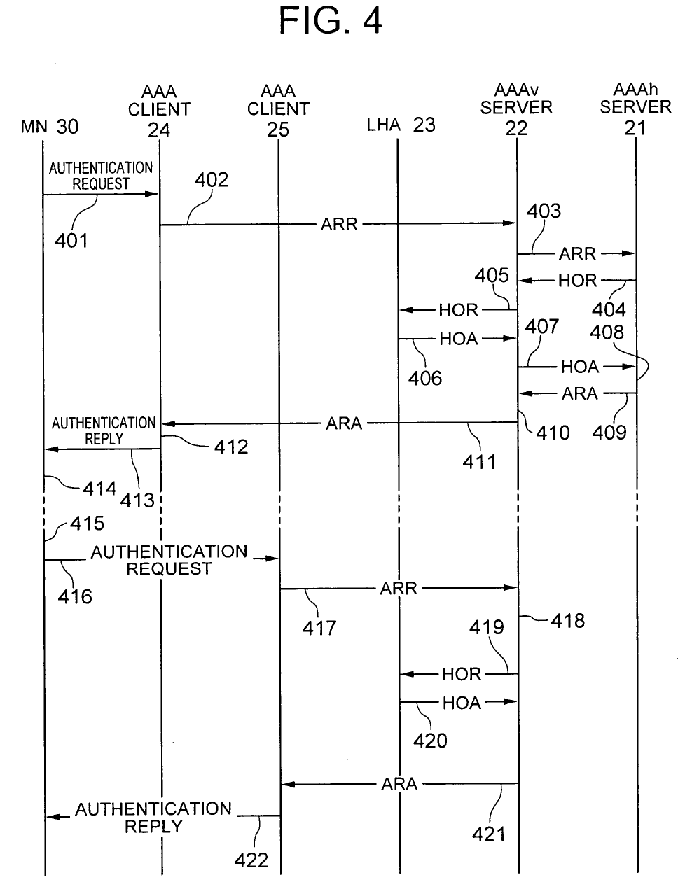

Next, the operation of the mobile communication network system of the present invention will be explained with reference to the sequence chart in FIG. 4.

First, an explanation will be given for a case that the mobile IP terminal 30 connects with the AAA client 24 in the visited domain 20. The mobile IP terminal 30 first obtains a challenge value (hereinafter referred to this value as LC1). The challenge value LC1 may be any value which can be obtained in such a manner that the mobile IP terminal 30 generates by itself a nonce, the same value of which will never be generated again, or that a nonce value, included in a message called a “Router Advertisement” message transmitted from the AAA client 24, is extracted, or the like.

Next, the mobile IP terminal 30 calculates a response value RS1 using the LC1 and the secret key Kmh. An algorism for calculating the response value RS1 is not limited specifically. However, an algorism used in the mobile IP terminal 30 and an algorism used in the AAAh server 12 must be the same. After calculating the response value RS1, the mobile IP terminal 30 transmits to the AAA client 24 an authentication request message including the NAI of itself, the challenge value LC1 and the response value RS1 (step 401).

The AAA client 24 extracts the NAI, the challenge value LC1, and the response value RS1 from the received authentication request message. Then, the AAA client 24 generates an ARR message including the NAI, the challenge value LC1 and the response value RS1 extracted, and transmits the message to the AAAv server 22 (step 402).

The AAAv server 22, upon receipt of the ARR message from the AAA client 24, searches for the next receiver referring to the routing table held by itself. In the case of the present embodiment, the receiver, which is the result of referring to the routing table, is the AAAh server 12, so that the AAAv server 22 transfers the received ARR message to the AAAh server 12 (step 403).

The AAAh server 12, upon receipt of the ARR message from the AAAv server 22, obtains the NAI, the challenge value LC1 and the response value RS1 included in the received ARR message. Next, the AAAh server 12 obtains the secret key Kmh, corresponding to the NAI obtained from the mobile IP terminal 30, from the database 13, and calculates the response value corresponding to the challenge value LC1 using the secret key Kmh (the result of which is assumed to be RS1′). Then, the AAAh server 12 compares the response value RS1 included in the received ARR message with the calculated response value RS1′. In the case of RS1=RS1′, the AAAh server 12 judges that the mobile IP terminal 30 has the secret key Kmh, and authenticates that the mobile IP terminal 30 is a user terminal having the proper right.

The AAAh server 12, after authenticating the mobile IP terminal 30, refers to the database 13 so as to search for sources that the authentication mobile IP terminal 30 is authorized to use. If it is judged that the mobile IP terminal 30 is authorized to use the network source, the AAAh server 12 determines the place where the home agent is to be assigned based on the request from the mobile IP terminal 30 and the policy set to the AAAh server 12. In the present embodiment, the home agent is assumed to be assigned in the visited domain 20. Then, the AAAh server 12 transmits a home agent request message(HOR:Home-Agent-MIPv6-Request) to the AAAv server 22 in the visited domain 20 (step 404).

The AAAv server 22, upon receipt of the HOR message from the AAAh server 12, assigns the home agent and the home address, and transmits the received HOR message to the assigned home agent (in the present embodiment, LHA 23) (step 405).

The LHA 23, upon receipt of the HOR message from the AAAh server 12, updates a binding cache entry used for transferring to the mobile IP terminal 30 a packet addressed to the home address of the mobile IP terminal 30, and returns to the AAAh server 12 the HOA(Home-Agent-MIPv6-Answer) which is a reply message to the HOR message (step 406).

The AAAv server 22, upon receipt of the HOA message from the LHA 23, transfers it to the AAAh server 12 (step 407). The AAAh server 12, upon receipt of the HOA message from the AAAv server 22, generates here the secret key Kmv which is temporarily shared by the mobile IP terminal 30 and the AAAv server 22, using the secret key generating unit 14 (step 408).

Next, the AAAh server 12 generates an ARA message which is a reply message to the ARR message, incorporating in the ARA message, the result of authentication (in this case, an access authorization), the NAI, the secret key Kmv, and information relating to the valid term of the secret key Kmv. When incorporating the secret key Kmv, the AAAh server 12 incorporates information in which the secret key Kmv is encrypted with the secret key Kmh, Kvh, respectively, (hereinafter referred to as Kmh(Kmv), Kvh(Kmv)) in order that the key is not to be known by other nodes than the AAAv server 12 and the mobile IP terminal 30. As a specific encryption method, although an encryption method such as DES(Data Encryption Standard) is known, any encryption method may be used in the present embodiment. The AAAh server 12 transmits the generated ARA message to the AAAv server 22 (step 409).

The AAAv server 22, upon receipt of the ARA message from the AAAh server 12, extracts the information Kvh(Kmv) incorporated in the received ARA message, and using the secret key Kvh which has been held, obtains the secret key Kmv (step 410). Then, the AAAv server 22 stores in the secret key storing unit 26 the obtained secret key Kmv, together with the NAI and the valid term included in the ARA message. Next, the AAAv server 22 transmits to the AAA client 24 the ARA message received from the AAAh server 12 (step 411).

The AAA client 24, upon receipt of the ARA message from the AAAv server 22, generates an authentication reply message corresponding to the authentication request received from the mobile IP terminal 30 in the step 401, incorporating therein the information Kmh(Kmv) together with the authentication result included in the ARA message (step 412). Then, the AAA client 24 transmits the generated authentication reply message to the mobile IP terminal 30 (step 413). The mobile IP terminal 30, upon receipt of the authentication reply message from the AAA client 24, extracts the information Kmh(Kmv) and the valid term data of the secret key Kmv from the received authentication reply message, and obtains the secret key Kmv using the secret key Kmh which has been held (step 414).

Next, the operation of a case that the mobile IP terminal 30 connecting with the AAA client moves within the visited domain 20 to thereby connect with the AAA client 25.

The mobile IP terminal 30 first generates or obtains the challenge value LC2 (step 415). Here, the challenge value LC2 can be obtained in such a manner that the mobile IP terminal 30 generates by itself a nonce, the value of which will never be generated again, or that a nonce value included in a message called a “Router Advertisement” transmitted from the AAA client 25 is extracted. Next, the mobile IP terminal 30 calculates the response value RS2 using the challenge value LC2 and the secret key Kmv. The response value RS2 is shown as the following equation:

RS2=f(Kmv, LC2, - - - )

Here, f( ) is a defined function. An algorism for calculating the response value RS2 from the challenge value LC2 and the secret key Kmv (that is, f) is not limited specifically in the present embodiment. Further, arguments of the function f, other than the challenge value LC2 and the secret key Kmv, depend on an algorism to be used. The mobile IP terminal 30, which obtained the challenge value LC2 and the response value RS2, then generates an authentication request message storing the challenge value LC2, the response value RS2 and the NAI, and transmits the message to the AAA client 25 (step 416).

Next, the AAA client 25, upon receipt of the authentication request message, generates an ARR message incorporating the response value RS2, the challenge value LC2, and the NAI which are included in the received authentication request message, and transmits the message to the AAAv server 22 (step 417).

The AAAv server 22 receives the ARR message from the AAA client 25. When recognizing that the response value RS2 and the challenge value LC2 are incorporated in the received ARR message, the AAAv server 22 extracts the secret key Kmv corresponding to the mobile IP terminal 30 from the secret key storing unit 221, using the NAI incorporated in the ARR message (step 418).

Next, the AAAv server 22 calculates a response value RS2′ using the challenge value LC2 and the secret key Kmv incorporated in the received ARR message. Here, the response value RS2′ is shown as the following equation:

RS2′=f(Kmv, LC2, - - - )

An algorism for calculating the response value RS2′ is the same as that used in the mobile IP terminal 30, which algorism is assumed to have been set beforehand for the mobile IP terminal 30 and the AAAv server 22.

Next, the AAAv server 22 compares the response value RS2 incorporated in the ARR message with the calculated response value RS2′. In the case of RS2=RS2′, the AAAv server 22 judges that the secret key held by the mobile IP terminal 30 and the secret key stored in the secret key storing unit 26 are the same. That is, the AAAv server 22 confirms that the mobile IP terminal 30 holds the same secret key as the secret key Kmv stored in the secret key storing unit 26, thereby being capable of authenticating that the mobile IP terminal 30 is a mobile IP terminal 30 of the user having the proper right. Therefore, after authenticating the mobile IP terminal 30, the AAAv server 22 does not transmit the ARR message to the AAAh server 12. Instead, the AAAv server 22 reassigns the home agent and the home address, which have been assigned to the mobile IP terminal 30, to the mobile IP terminal 30 which is now authenticated, then generates the HOR message, and transmits the HOR message to the assigned home agent (in the present embodiment, LHA 23) (step 419).

The LHA 23, upon receipt of the HOR message from the AAAv server 22, updates the binding cache entry for use in transmitting a packet, and returns to the AAAv server 22 an HOA(Home-Agent-MIPv6-Answer) message which is a reply message to the HOR message (step 420).

The AAAv server 22, upon receipt of the HOA message from the LHA 23, generates an ARA message which is a reply message to the received ARR message, incorporating in the ARA message the authentication result (in this case, an access authorization), and transmits the message to the AAA client 25 (step 421).

The AAA client 25, upon receipt of the ARA message from the AAAv server 22, generates an authentication reply message incorporating the authentication result included in the received ARA message. Then, the AAA client 25 transmits to the mobile IP terminal 30 the generated authentication reply message (step 422).

After this step, if the valid term of the secret key Kmv is coming during communications by the mobile IP terminal 30, the sequence from the steps 401 to 411 is repeated again. In this way, the mobile IP terminal 30 and the AAAv server 22 can obtain a new secret key from the AAAh server 12.

In the present embodiment, the AAAh server 12 issues to a reliable AAAv server, that is, the AAAv server 22 which has already shared the secret key Kvh, a temporary secret key Kmv for being shared by the mobile IP terminal 30 and the AAAv server 22, to thereby authorize the AAAv server 22 to authenticate the mobile IP terminal 30. If the information encrypted with the secret key Kvh is received by a node not having the secret key Kvh, the secret key Kmv cannot be decrypted correctly, so that only wrong information is obtained.

Accordingly, even though the authority to authenticate the mobile IP terminal 30 is assigned from the AAAh server 12 to the AAAv server 22, like the mobile terminal authentication method in the present embodiment, the safety of the authentication will never deteriorated. Further, the secret key Kmv, which is different from the secret key Kmh which have been shared by the AAAh server 12 and the mobile IP terminal 30, is issued to the AAAv server 22. Therefore, it is possible to avoid exposing information kept by the AAAh server 12 to other providers. When the authority to authenticate the mobile IP terminal 30 is assigned from the AAAh server 12 to the AAAv server, it is not required to exchange ARR/ARA, HOR/HOA messages, which occurs between the AAAv server 22 and the AAAh server 12. The section between the AAAv server 22 and the AAAh server 12 is the most distant comparing with the other sections, because of the nature of each node. With the message exchange of two round trips being eliminated, the time period required for the entire authentication can be significantly reduced.

(Second Embodiment)

Next, a mobile communication network system according to a second embodiment of the present invention will be explained.

In the aforementioned mobile communication network system of the first embodiment, the mobile IP terminal 30 calculates the response value RS2 using the challenge value LC2 and the secret key Kmv. In the present embodiment, the mobile IP terminal 30 calculates the response value RS2 using current time data, instead of the challenge value LC2.

Although the structure of the present embodiment is similar to that of the first embodiment shown in FIG. 3, each of the mobile IP terminal 30 and the AAAv server 22 is provided with a clock inside thereof, and the time of the mobile IP terminal 30 and the time of the AAAv server are coincide with each other within a range of precision used in the following calculation.

The operation of the present embodiment will be explained referring to FIG. 4. The operation from the step 401 to the step 414 is similar to that in the first embodiment described above. Assuming that the mobile IP terminal 30 moves to thereby switch connection from the AAA client 24 to the AAA client 25. Here, the mobile IP terminal 30 calculates the response value RS2 using the current time t1 as follows:

RS2=g(Kmv, t1, - - - )

Here, go is a certain function.

When the response value RS2 is obtained as described above, the mobile IP terminal generates an authentication request message, incorporating the NAI and the response value RS2 in the authentication request message, and transmits the message to the AAA client 25 (step 416).

Next, the AAA client 25, upon receipt of the authentication request message from the mobile IP terminal 30, generates an ARR message incorporating the response value RS2 and the NAI which are incorporated in the received authentication request message, and transmits this message to the AAAv server 22 (step 417).

The AAAv server 22, upon receipt of the ARR message from the AAA client 25, recognizes that the response value RS2 is incorporated in the received ARR message and then extracts the secret key Kmv corresponding to the mobile IP terminal 30 from the secret key storing unit 26, using the NAI stored in the ARR message (step 418).

Then, the AAAv server 22 calculates the response value RS2′ using the time data t2 obtained from the clock provided therein and using the secret key Kmv.

The response value RS2′ is shown as the following equation:

RS2′=g(Kmv, t2, - - - )

Here, the algorism g for calculating the response value RS2′ is same as the one used at the mobile IP terminal 30 side, which algorism is assumed to have been set beforehand for the mobile IP terminal 30 and the AAAv server 22. On the other hand, the time of the mobile IP terminal 30 and the time of the AAAv server 22 have been set to coincide with each other, so that t1=t2 is established.

Next, the AAAv server 22 compares the response value RS2 incorporated in the received ARR message with the calculated response value RS2′. In the case of RS2=RS2′, the AAAv server 22 judges that the secret key held by the mobile IP terminal 30 and the secret key stored in the secret key storing unit 26 are the same. That is, the AAAv server 22 confirms that the mobile IP terminal 30 holds the secret key which is same as the secret key Kmv stored in the secret key storing unit 26 to thereby be capable of authenticating that the mobile IP terminal 30 is a mobile IP terminal of the user having the proper right. The operation thereafter is same as that of the first embodiment described above.

The effects of the present embodiment is that there is no need to transmit the challenge value LC2 in the steps 416 and 417. Therefore, the present embodiment is particularly useful in a case that the protocol has already been set and there is no field into which the value of the challenge value LC2 is to be incorporated.

(Third Embodiment)

Next, a mobile communication network system according to a third embodiment of the present invention will be explained.

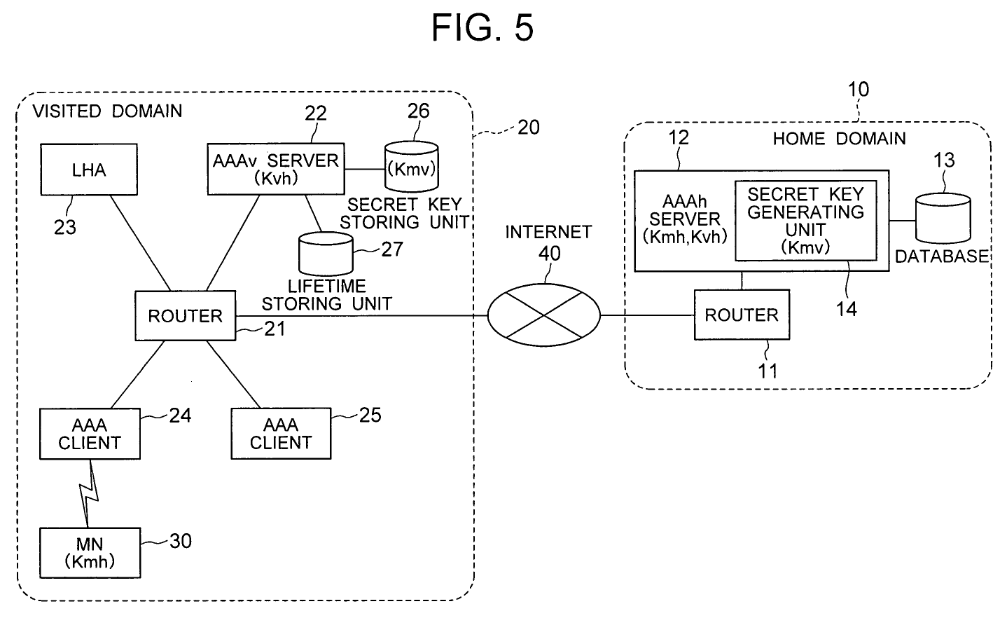

FIG. 5 shows the structure of the present embodiment. Comparing with the mobile communication network system according to the first embodiment shown in FIG. 3, the present embodiment is different in that a lifetime storing unit 27 is additionally connected with the AAAv server 22.

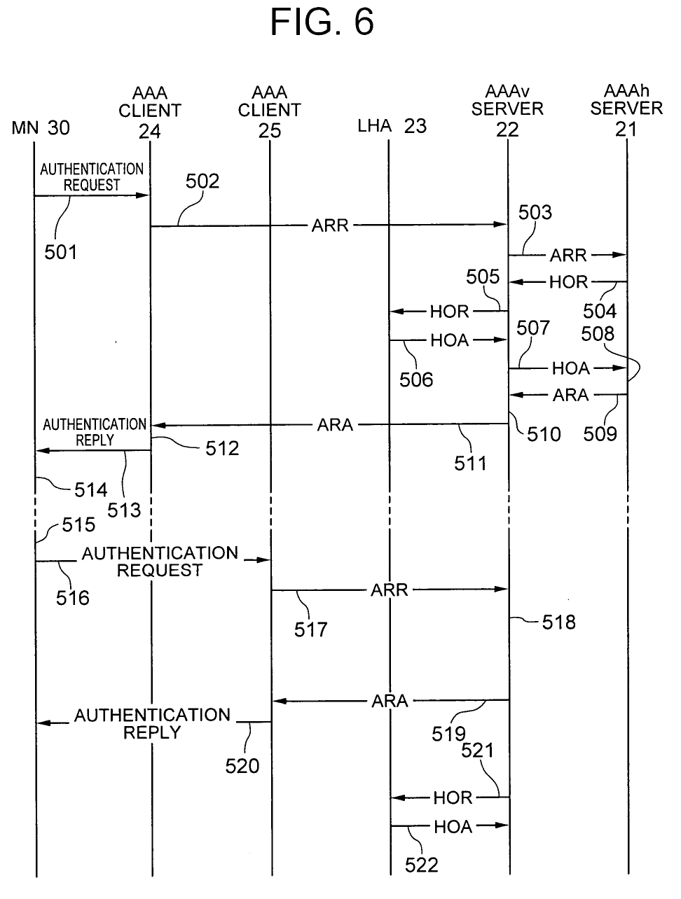

The operation of the present embodiment will be explained using the sequence chart shown in FIG. 6. Except for a part between the step 504 and the step 505, the explanation from the step 501 to the step 518 is same as that from the step 401 to the point right before the HOR message is transmitted in the step 418, explained in FIG. 4. Therefore, explanations will only be given for the part different from the steps 504 to 505, and the operation after the step 518.

First, the point different from the step 504 to 05 is that a new step is added, in which the AAAv server 22, prior to transmitting the HOR message to the LHA 23, causes the NAI included in the HOR message, the home agent assigned, the current time, and a lifetime which is a time period within which the mobile IP terminal can use the home agent, to be stored in the lifetime storing unit 27.

Next, the operation after the step 518 will be explained. After assigning the home agent and the home address to the mobile IP terminal 30, the AAAv server 22 obtains, using the NAI transmitted in the ARR message, the home agent which has been assigned to the mobile IP terminal 30 holding the NAI, the time of authentication and the lifetime from the life time storing unit 27. Then, the AAAv server 22 looks into whether the home agent assigned this time coincides with the former one which can be obtained from the lifetime storing unit 27. If the both home agents coincide with each other, the AAAv server 22 looks into the remaining period during which the mobile IP terminal 30 can use the home agent. This can be calculated from the current time data, the time data at the time of authentication obtained from the lifetime storing unit 27, and the lifetime data. If the remaining period shows a large enough value comparing with the period required for exchanging the HOR message and the HOA message with the LHA 23 and processing them, the AAAv server 22 postpones exchanging the HOR message and the HOA message with the LHA 23, and transmits the ARA message first (step 519). Then, the AAAv server 22 transmits the HOR message to the LHA 23 assigned (step 521).

The LHA 23, upon receipt of the HOR message, performs processing as same as that in the aforementioned embodiments, and transmits the HOA message to the AAAv server 22 (step 522). Further, the AAA client 25, upon receipt of the ARA message, performs processing as same as that in the aforementioned embodiments and transmits an authentication reply to the mobile IP terminal 30 (step 520).

The effect of the present embodiment is, in addition to the effects of the aforementioned embodiments, it is possible to reduce a time period necessary for exchanging the HOR message and the HOA message between the AAAv server 22 and the LHA 23.

The aforementioned first to third embodiments explain the case that when the AAAh server 12 in the home domain transmits the secret key Kmv generated in the secret key generating unit 14 to the AAAv server 22 and to the mobile IP terminal 30, respectively, the AAAh server 12 first encrypts the secret key Kmv using the secret keys Kvh and Kmh, and then transmits them in order that the contents never be revealed to other nodes. However, the present invention is not limited to this. The present invention may be similarly applied to a case of transmitting the secret key Kmv using other methods which prevent the contents of the secret key Kmv from being revealed to other nodes.

(Effect of the Invention)

According to the present invention, the same secret key is transmitted from the AAA server in the home domain to the AAA server in the visited domain and to the mobile IP terminal to thereby assign the authority of authenticating the mobile IP terminal from the AAA server in the home domain to the AAA server in the visited domain, as described above. Accordingly, even when the mobile IP terminal moves within the visited domain so that there arises a necessity to authenticate the mobile IP terminal, a message exchange between the AAAv server and the AAAh server is not required, which provides an effect that a time period required for authentication can be significantly reduced.

What is claimed is:

1. A mobile terminal authentication method in a mobile communication network system in which a home network, to which a mobile terminal subscribes, and a visited network, to which the mobile terminal does not subscribe, connect with each other over the Internet, the mobile terminal authentication method being such a method that an authentication of a mobile terminal moved from a domain of the home network to a visited domain of the visited network is performed by an AAAv server in the visited network, the method comprising the steps of:
notifying, from the AAAv server in the visited network to an AAAh server in the home network, an authentication request from the mobile terminal moved to the visited domain of the visited network; and
upon receipt of a notification, issuing, from the AAAh server in the home network to the AAAv server in the visited network, a temporal secret key which is to be shared by the mobile terminal and the AAAv server, and assigning an authority to authenticate the mobile terminal to the AAAv server.

2. The mobile terminal authentication method, as claimed in claim 1, wherein the AAAh server in the home network issues the temporal secret key to be shared by the mobile terminal and the AAAv server after authenticating the mobile terminal, and assigns the authority to authenticate the mobile terminal to the AAAv server.

3. A mobile terminal authentication method in a mobile communication network system in which a home network, to which a mobile terminal subscribes, and a visited network, to which the mobile terminal does not subscribe, connect with each other over the Internet, the mobile terminal authentication method being such a method that an authentication of a mobile terminal moved from a domain of the home network to a visited domain of the visited network is performed by an AAAv server in the visited network, the method comprising the steps of:
notifying an authentication request, made to the AAAv server in the visited network by the mobile terminal moved to the visited domain, from the AAAv server in the visited network to an AAAh server in the home network;
by the AAAh server, receiving the authentication request from the AAAv server and authenticating the mobile terminal, as well as generating a secret key to be shared temporarily by the mobile terminal and the AAAv server; and
by the AAAh server, transmitting a generated secret key to the AAAv server from which the authentication request was transmitted and to the mobile terminal, respectively.

4. The mobile terminal authentication method, as claimed in claim 3, further comprising the steps of:
when an authentication is required again since the mobile terminal moves, making an authentication request from the mobile terminal to the AAAv server based on information generated using the secret key transmitted from the AAAh server; and
authenticating the mobile terminal, by the AAAv server, using the information included in the authentication request transmitted from the mobile terminal and using the secret key transmitted from the AAAh server.

5. A mobile terminal authentication method in a mobile communication network system in which a home network, to which a mobile terminal subscribes, and a visited network, to which the mobile terminal does not subscribe, connect with each other over the Internet, the mobile terminal authentication method being such a method that an authentication of a mobile terminal moved from a domain of the home network to a visited domain of the visited network is performed by an AAAv server in the visited network, the method comprising the steps of:
when the mobile terminal existing in the visited domain makes an authentication request to the AAAv server, transmitting the authentication request received by the AAAv server to an AAAh server in the home network of the mobile terminal;
by the AAAh server, receiving the authentication request from the AAAv server and authenticating the mobile terminal, as well as generating a secret key to be shared temporarily by the mobile terminal and the AAAv server;
by the AAAh server, transmitting a generated secret key to the AAAv server from which the authentication request was transmitted and to the mobile terminal, respectively;
by the AAAv server, assigning a home agent to the mobile terminal, setting a lifetime which is a time period within which the mobile terminal can use the home agent, and storing information about the lifetime and a time the lifetime was set; and
when the lifetime expires, transmitting an authentication reply message to the mobile terminal before transmitting a home agent request message to the home agent.

6. The mobile terminal authentication method, as claimed in claim 5, further comprising the steps of:
when an authentication is required again since the mobile terminal moves, making an authentication request from the mobile terminal to the AAAv server based on information generated using the secret key transmitted from the AAAh server;
authenticating the mobile terminal, by the AAAv server, using the information included in the authentication request transmitted from the mobile terminal and using the secret key transmitted from the AAAh server, and assigns a home agent to the mobile terminal;
if the home agent which has been assigned to the mobile terminal coincides with the home agent which is assigned this time, calculating a remaining period within which the mobile terminal can use the home agent based on a current time, the lifetime of the home agent stored, and the time the lifetime was set; and
if the remaining period is longer than a certain time period set beforehand, transmitting the authentication reply message to the mobile terminal before transmitting the home agent request message to the home agent.

7. The mobile terminal authentication method, as claimed in claim 5, wherein the information, generated by the mobile terminal using the secret key transmitted from the AAAh server when the authentication request is made to the AAAv server, is a response value calculated using a challenge value, which may take any value, and the secret key.

8. The mobile terminal authentication method, as claimed in claim 6, wherein the information, generated by the mobile terminal using the secret key transmitted from the AAAh server when the authentication request is made to the AAAv server, is a response value calculated using a challenge value, which may take any value, and the secret key.

9. The mobile terminal authentication method, as claimed in claim 5, wherein the information, generated by the mobile terminal using the secret key transmitted from the AAAh server when the authentication request is made to the AAAv server, is a response value calculated using current time information and the secret key.

10. The mobile terminal authentication method, as claimed in claim 6, wherein the information, generated by the mobile terminal using the secret key transmitted from the AAAh server when the authentication request is made to the AAAv server, is a response value calculated using current time information and the secret key.

11. The mobile terminal authentication method, as claimed in claim 2, wherein a method of transmitting, by the AAAh server, a generated secret key to the AAAv server from which the authentication request was transmitted and to the mobile terminal, is a method in which the secret key is encrypted using another secret key which is different from the generated secret key and has been set beforehand for the AAAh server and the AAAv server, and using yet another secret key which is different from the generated secret key and has been set beforehand for the AAAh server and the mobile terminal, respectively, before transmitted.

12. A mobile communication network system in which a home network, to which a mobile terminal subscribes, and a visited network, to which the mobile terminal does not subscribe, connect with each other over the Internet, wherein
the visited network comprises an AAAv server, and
the AAAv server, when receiving an authentication request from the mobile terminal for a first time, transmits the authentication request to an AAAh server in the home network of the mobile terminal to thereby authenticate the mobile terminal, and holds a secret key received from the AAAh server with an authentication result, and when receiving an authentication request from the mobile terminal next time, authenticates the mobile terminal using information included in the authentication request transmitted from the mobile terminal and the secret key which has been held by itself, wherein
the home network comprises the AAAh server, and
the AAAh server has secret key generating means for generating a secret key which is to be shared temporarily by the mobile terminal and the AAAv server, and when receiving an authentication request from the AAAv server, authenticates the mobile terminal and transmits the secret key generated by the secret key generating means to the AAAv server from which the authentication request was transmitted and to the mobile terminal, and
using, as a trigger, the authentication request from the mobile terminal in the visited domain in which the visited network is formed, the authentication of the mobile terminal by the AAAv server in the visited network is performed using the secret key transmitted from the AAAh server in the home network.

13. The mobile communication network system, as claimed in claim 12, wherein when an authentication is required again since the mobile terminal moves after authentication, the AAAv server in the visited network authenticates the mobile terminal based on information generated using the secret key held by itself.

14. The mobile communication network system as claimed in claim 12, wherein the information, generated by the mobile terminal using the secret key transmitted from the AAAh server when the authentication request is made to the AAAv server, is a response value calculated using a challenge value, which may take any value, and the secret key.

15. The mobile communication network system as claimed in claim 12, wherein the information, generated by the mobile terminal using the secret key transmitted from the AAAh server when the authentication request is made to the AAAv server, is a response value calculated using current time information and the secret key.

16. The mobile communication network system, as claimed in claim 12, wherein a system of transmitting, by the AAAh server, the generated secret key to the AAAv server from which the authentication request was transmitted and to the mobile terminal, is a system in which the secret key is encrypted using another secret key which is different from the generated secret key and has been set beforehand for the AAAh server and the AAAv server, and using yet another secret key which is different from the generated secret key and has been set beforehand for the AAAh server and the mobile terminal, respectively, before transmitted.

17. A mobile communication network system in which a home network, to which a mobile terminal subscribes, and a visited network, to which the mobile terminal does not subscribe, connect with each other over the Internet, wherein
the visited network comprises an AAAv server, and
the AAAv server, when receiving an authentication request from the mobile terminal for a first time, transmits the authentication request to an AAAh server in the home network of the mobile terminal to thereby authenticate the mobile terminal, holds a secret key received from the AAAh server with an authentication result, assigns a home agent to the mobile terminal, sets a lifetime which is a time period within which the mobile terminal can use the home agent, and stores information about the lifetime and a time the lifetime was set, and when receiving an authentication request from the mobile terminal next time, authenticates the mobile terminal using information included in the authentication request transmitted from the mobile terminal and the secret key which has been held by itself, and assigns the home agent to the mobile terminal, and if the home agent which has been assigned to the mobile terminal coincides with the home agent which is assigned this time, calculates a remaining period within which the mobile terminal can use the home agent based on a current time, the lifetime of the home agent stored, and the time the life time was set, and if the remaining period is longer than a certain time period set beforehand, transmits an authentication reply message to the mobile terminal before transmitting the home agent request message to the home agent; wherein
the home network comprises the AAAh server, and
the AAAh server has secret key generating means for generating a secret key which is to be shared temporarily by the mobile terminal and the AAAv server, and when receiving an authentication request from the AAAv server, authenticates the mobile terminal and transmits the secret key generated in the secret key generating means to the AAAv server from which the authentication request was transmitted and to the mobile terminal, and
using, as a trigger, the authentication request from the mobile terminal in the visited domain in which the visited network is formed, the authentication of the mobile terminal by the AAAv server in the visited network is performed using the secret key transmitted from the AAAh server in the home network.

18. The mobile communication network system, as claimed in claim 17, wherein when an authentication is required again since the mobile terminal moves after authentication, the AAAv server in the visited network authenticates the mobile terminal based on information generated using the secret key held by itself.

19. The mobile communication network system as claimed in claim 17, wherein the information, generated by the mobile terminal using the secret key transmitted from the AAAh server when the authentication request is made to the AAAv server, is a response value calculated using a challenge value, which may take any value, and the secret key.

20. The mobile communication network system as claimed in claim 17, wherein the information, generated by the mobile terminal using the secret key transmitted from the AAAh server when the authentication request is made to the AAAv server, is a response value calculated using current time information and the secret key.

21. The mobile communication network system, as claimed in claim 17, wherein a system of transmitting, by the AAAh server, the generated secret key to the AAAv server from which the authentication request was transmitted and to the mobile terminal, is a system in which the secret key is encrypted using another secret key which is different from the generated secret key and has been set beforehand for the AAAh server and the AAAv server, and using yet another secret key which is different from the generated secret key and has been set beforehand for the AAAh server and the mobile terminal, respectively, before transmitted.
